(19) United States
(12) Patent Application Publication
(10) Pub. No.: US 2007/0186225 A1
(43) Pub. Date: Aug. 9, 2007

(54) Optical pickup device and an optical disc drive including the same

(75) Inventor: Tatsuhiro Asabata, Echizen-city (JP)

Correspondence Address: JORDAN AND HAMBURG LLP, 122 EAST 42ND STREET, SUITE 4000, NEW YORK, NY, 10168, US

(73) Assignee: ORION ELECTRIC Co., Ltd., Echizen-city (JP)

(21) Appl. No.: 11/656,269

(22) Filed: Jan. 22, 2007

(30) Foreign Application Priority Data
Jan. 23, 2006 (JP) 2006-013296

(51) Int. Cl. G11B 33/12

(52) U.S. Cl. 720/652

(57) ABSTRACT

A second land SLG has a size to pool a sufficient quantity of solder H for allowing the steps of shorting and unshorting a first land SLP and the second land SLG to be repeated plural times. Out of the solder H initially supplied to a short land portion, therefore, a solder portion H bridging a gap between the first and second lands SLP, SLG for shorting may be transferred to and pooled on the second land SLG, whereby the shorted state may be eliminated. When the short land portion is reshorted, the short land portion may be electrically shorted by transferring the solder H on the second land SLG to the first land SLP. This permits the steps of shorting and unshorting the short land portion to be repeated plural times without replenishing fresh solder H. Thus, the solder H may be saved.

### CROSS REFERENCE TO RELATED APPLICATION

The disclosure of Japanese Patent Applications enumerated below including specification, drawings and claims is incorporated herein by reference in its entirety:

No. 2006-013296 filed Jan. 23, 2006.

### BACKGROUND OF THE INVENTION

1. Field of the Invention

The present invention relates to an optical pickup device for optical disc and an optical disc drive including the same.

2. Description of the Related Art

An optical disc drive has conventionally been known which uses a so-called optical disc such as a DVD and CD as a recording medium for recording predetermined information or for reproducing previously recorded information. The optical disc drive records the information in the optical disc or reproduces the information from the optical disc. This optical disc drive includes an optical pickup unit, a laser diode of which irradiates a light beam on a recording surface of the optical disc so as to write information to the recording surface or to retrieve information from the recording surface for reproduction.

By the way, the above laser diode may sometimes sustain electrostatic breakdown caused by static electricity. The following measure has generally been adopted to prevent such an electrostatic breakdown of the laser diode. As illustrated by an apparatus disclosed in Japanese Unexamined Patent Publication No. 2002-279670, for example, a short land portion for electrically shorting a source terminal and a ground terminal of the laser diode is provided on a circuit board of the optical pickup unit. In this case, the above short land portion is electrically shorted by way of a solder so as to prevent the electrostatic breakdown of the laser diode when the optical pickup unit is assembled in the above optical disc drive.

### SUMMARY OF THE INVENTION

The short land portion of this type is subjected to a shorting step and an unshorting step, the steps performed using a soldering iron and a solder. A specific procedure is described with reference to FIG. 8.

FIG. 8 is a group of enlarged schematic diagrams showing a conventional short land portion. FIG. 8A is a plan view of the short land portion. FIG. 8B and FIG. 8C are sectional views taken on the line C-C in FIG. 8A. FIG. 8B shows a state where a first land SLP3 and a second land SLG3 of a short land portion SL4 shown in FIG. 8A are electrically shorted by way of a solder H. FIG. 8C shows a state where the shorted state of FIG. 8B is eliminated.

As shown in FIGS. 8A through 8C, the short land portion SL4 may be formed in any configuration by overlaying an insulative ink film, called a resist SR3, on a circuit pattern PW3 formed on a circuit board 641, the circuit pattern formed of a copper foil or the like. As shown in FIG. 8B and FIG. 8C, the solder H is not deposited on the resist SR3.

In the fabrication of the optical disc drive, the short land portion SL4 electrically shorted by way of the solder H, as shown in FIG. 8B, is removed of a part of the solder H by means of the soldering iron whereby the short land portion SL4 is unshorted as shown in FIG. 8C. Subsequently when the short land portion SL4 is reshorted, fresh solder H must be replenished by means of the soldering iron.

In the case of the short land portion of the conventional structure, repeated shorting and unshorting steps require the fresh solder H to be replenished each time the short land portion SL4 is electrically shorted.

It is an object of the invention to provide for the repeated steps of shorting and unshorting the short land portion without replenishing the fresh solder.

According to a first aspect of the invention for achieving the above object, an optical pickup device comprises a short land portion provided on a circuit board for the purpose of preventing the electrostatic breakdown of a laser diode, and is characterized in that the short land portion includes at least one first land and at least one second land for solder pooling, the first and second lands subjected to shorting and unshorting steps by way of a solder, and that the second land has a size to pool a sufficient quantity of solder for allowing the steps of shorting and unshorting the lands to be repeated plural times.

According to the optical pickup device of the first aspect hereof, the second land has such a size as to pool a sufficient quantity of solder for allowing the steps of shorting and unshorting the first and second lands to be repeated plural times. Therefore, out of the solder initially supplied to the short land portion, a solder portion bridging a gap between these lands for shorting may be transferred to and pooled on the second land, whereby the shorted state may be eliminated. When the short land portion is reshorted, the solder pooled on the second land may be used for electrically shorting the short land portion. Unlike a conventional device, the optical pickup device of the invention negates the need for replenishing fresh solder each time the short land portion is shorted out, permitting the steps of shorting and unshorting the short land portion to be repeated plural times while using only the solder initially supplied to the short land portion. Thus, the solder may be saved.

According to a second aspect of the invention, an optical pickup device is characterized in that the second land has a greater area than the first land.

According to the optical pickup device of the second aspect hereof, the second land has the greater area than the first land, so that the second land is capable of pooling the solder when the short land portion is unshorted. Thus, the optical pickup device of the first aspect hereof may be implemented in a useful constitution.

According to a third aspect of the invention, an optical pickup device is characterized in that mutually opposing edges of the first land and the second land define parallel straight lines substantially having the same length.

According to the optical pickup device of the third aspect hereof, the opposing edges of these lands extend in parallel to each other and in the same length. Therefore, the short land portion may be easily and assuredly shorted or unshorted by way of the solder.

According to a fourth aspect of the invention, an optical pickup device is characterized in that the first land has a semicircular shape and the second land has a rectangular shape in which at least a side adjoining the first land has a length substantially equal to a diameter of the first land.

The optical pickup device of the fourth aspect hereof facilitates the formation of a wiring pattern of a circuit board, on which the first and second lands of the short land portion are formed. Furthermore, the second land may be so formed as to have the greater area than the first land while the mutually opposing sides of these lands have the same length. Thus is provided the optical pickup device featuring quite a useful constitution.

According to a fifth aspect of the invention, an optical disc drive comprises the optical pickup device according to any one of the first to fourth aspects of the invention.

The optical disc drive according to the fifth aspect hereof comprises the optical pickup device according to any one of the first to fourth aspects hereof. In the fabrication of the optical disc drive, therefore, the optical pickup device may be assembled in the optical disc drive without wastefully using the solder.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a plan view of an optical disc drive according to one embodiment of the invention showing a state where a tray is moved into the optical disc drive with its top opened;

FIG. 2 is a partially cut-away sectional view of the optical disc drive according to the one embodiment hereof showing a state where the optical disc drive has its tray removed and has its clamper partially cut away;

FIG. 3 is a plan view showing a single body of optical pickup unit of the optical disc drive according to the one embodiment hereof;

FIG. 4 is an enlarged plan view showing a potion enclosed by a dot-dash line in FIG. 3;

FIG. 5 is a group of enlarged schematic diagrams showing a short land portion;

FIG. 6 is a group of enlarged schematic diagrams showing a short land portion in comparison with the short land portion of an optical pickup unit of the embodiment shown in FIG. 5;

FIG. 7 is a flow chart showing the steps of one exemplary procedure of assembling the optical pickup unit in the optical disc drive; and

FIG. 8 is a group of enlarged schematic diagrams showing a conventional short land portion.

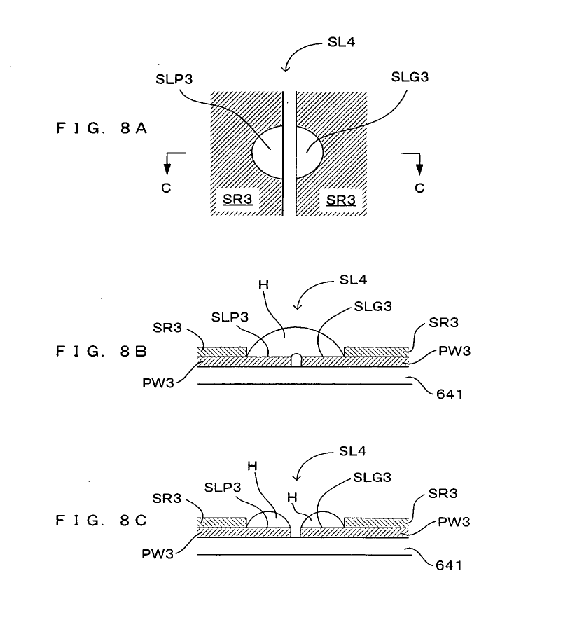

### DETAILED DESCRIPTION OF THE PREFERRED EMBODIMENTS

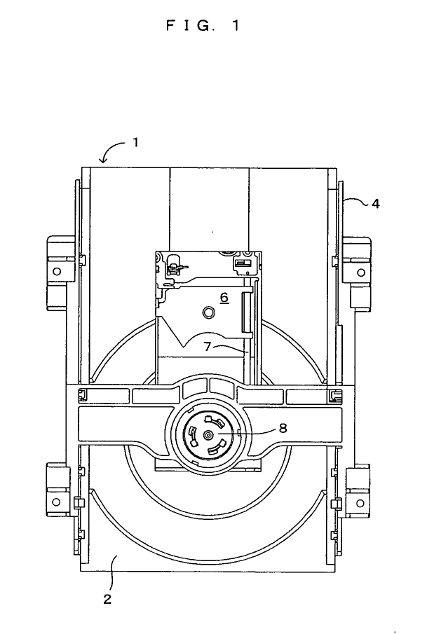

Next, referring to FIG. 1 through FIG. 7, one embodiment of the invention will be described in details to provide a more specific explanation of the invention. While the following description is made on the embodiment wherein the invention is applied to an optical disc drive for reproducing information retrieved from an optical disc such as a DVD and a CD or recording/reproducing the information in/from the optical disc, it is noted that the invention is not limited to this.

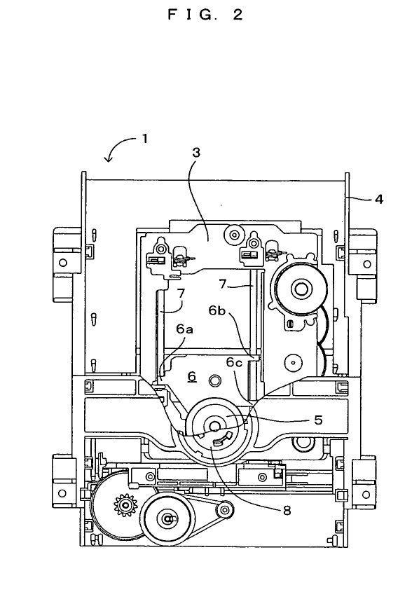

FIG. 1 and FIG. 2 each show a state where an optical disc drive has its upper part opened by removing a plate thereof. FIG. 1 is a plan view showing the optical disc drive having its tray moved therein. FIG. 2 is a partially cut-away sectional view showing the optical disc drive removed of the tray shown in FIG. 1 and having a clamper partially cut away.

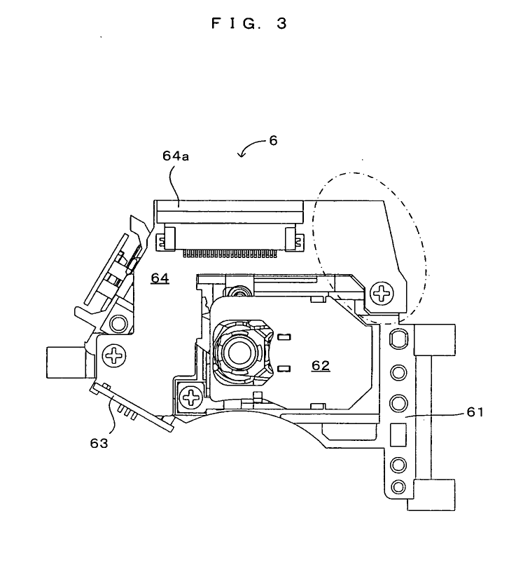

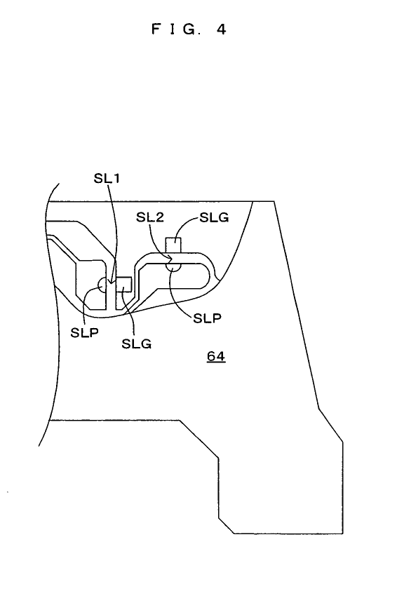

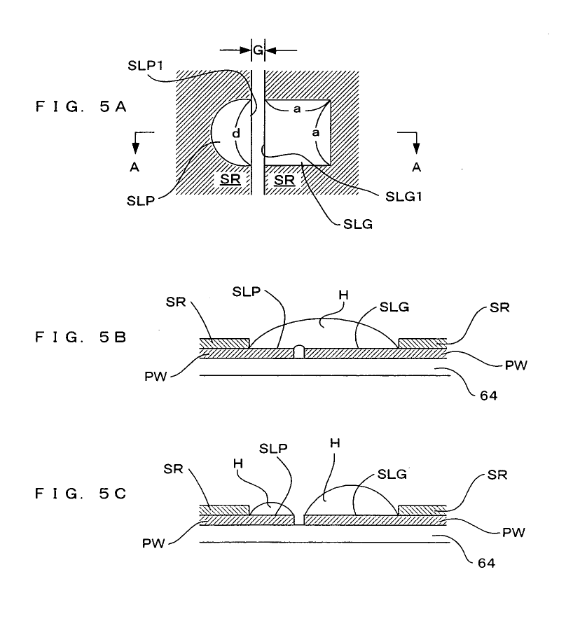

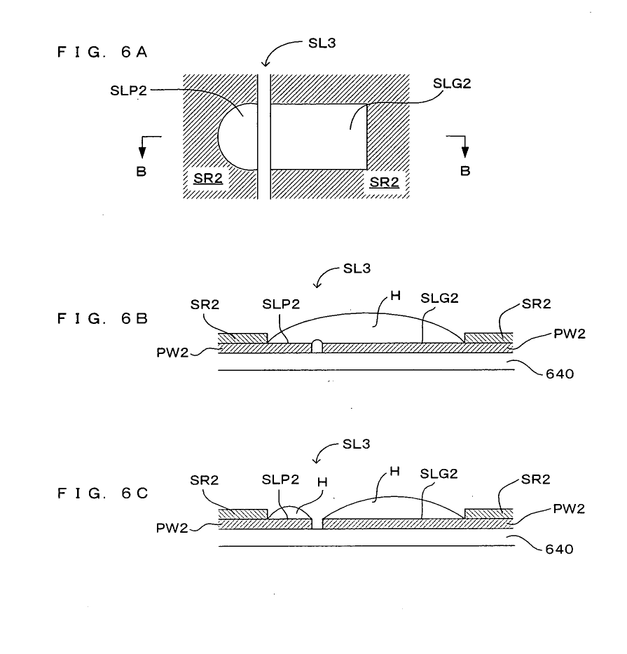

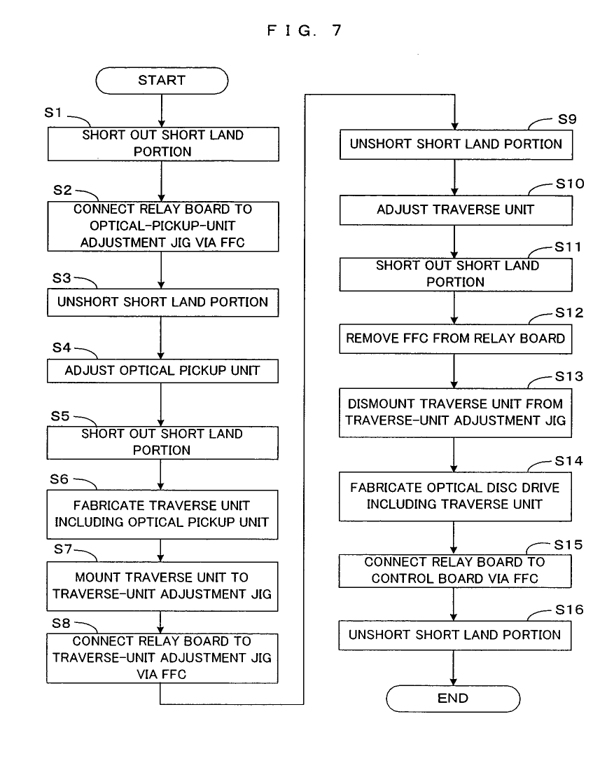

FIG. 3 is a plan view showing a single body of optical pickup unit (equivalent to an “optical pickup device” of the invention) assembled in the optical disc drive. FIG. 4 is an enlarged plan view showing a potion enclosed by a dot-dash line in FIG. 3. FIG. 5 is a group of enlarged schematic diagrams showing a short land portion. FIG. 6 is a group of enlarged schematic diagrams showing a short land portion in comparison with the short land portion of the optical pickup unit of the embodiment shown in FIG. 5. FIG. 7 is a flow chart showing the steps of one exemplary procedure of assembling the optical pickup unit in the optical disc drive.

As shown in FIG. 1 and FIG. 2, an optical disc drive 1 according to the embodiment has a function to reproduce information retrieved from an optical disc such as a DVD or a CD or functions to record/reproduce the information in/from the optical disc. The following components are disposed on a chassis 3 in a synthetic-resin frame 4 opening at an upper side. The components include: a turntable 5 which turns as carrying thereon an optical disc (not shown) in an uplifted position, the optical disc loaded, by means of a tray 2, from the outside of an electronic apparatus (not shown), for example, incorporating the optical disc drive 1; an optical pickup unit 6 irradiating a laser beam on a recording surface of the optical disc on the turntable 5 for recording information in the optical disc or reproducing the information from the optical disc; a pair of parallel guide shafts 7 disposed on lateral sides of the optical pickup unit 6; and the like.

A structure essentially including the above turntable 5, optical pickup unit 6 and guide shafts 7 mounted to the chassis 3 is generally referred to as a traverse unit. The traverse unit is assembled in the main-body frame 4 in a manner to be pivotally movable about one end thereof.

Similarly to a chassis constituting the known traverse unit, the chassis 3 is formed of a metal sheet such as an iron sheet. The chassis 3 is connected with the main-body frame 4 at one end thereof (rear end), so that the other end thereof (front end) is adapted to pivot about the connection portion to tilt up or down. Prior to the loading (insertion) of the optical disc when the tray 2 is moved out of the electronic apparatus, the chassis pivots about the above connection portion to tilt its front end downward. When the optical disc is loaded as carried from the outside of the electronic apparatus to a predetermined position in the main-body frame 4 by means of the tray 2, the chassis 3 in the forwardly tilted position pivots about the connection portion with the main-body frame 4 so as to tilt up to a horizontal position.

A clamper 8 (disc clamper) is mounted to place opposite the turntable 5. The clamper 8 clamps the optical disc along with the turntable 5 when the turntable 5 mounted to the chassis 3 is elevated by the pivotal tilting motion of the chassis 3, so as to lift up the optical disc placed on the tray 2. Similarly to the common disc clamper, this clamper 8 is free to rotate and is adapted to clamp the rotated optical disc onto the turntable by way of a magnetic attractive force between a magnet contained in the clamper 8 and a magnetic material of the turntable. The clamper 8 is mounted to the main-body frame 4 via a minor vertical gap (allowance) defined therebetween such that the clamper is also allowed to move up or down slightly according to warpage or the like of the rotated optical disc.

When the tray 2 is moved to the predetermined position in the main-body frame 4 in this manner, the optical disc on the tray 2 is placed in a slightly lifted position by the turntable 5 elevated in conjunction with the pivotal tilting motion of the chassis 3. When the chassis 3 is in the horizontal position, the optical disc is in a rotatable state to permit the optical disc recording or reproduction.

On the other hand, the guide shafts 7 are both formed from a metal, for example. The guide shafts are disposed in parallel on the lateral opposite sides of the optical pickup unit 6 for permitting the optical pickup unit 6 to reciprocate linearly in a radial direction of the optical disc (fore-and-aft direction) in a range between an inner circumferential end and an outer circumferential end of the optical disc. As shown in FIG. 2, the guide shafts 7 extend through support projections 6a through 6c of the optical pickup unit 6 for slidably movably supporting the optical pickup unit 6 in an uplifted position from the chassis 3.

Next, an arrangement of the optical pickup unit 6 will be described with reference to FIG. 3 through FIG. 5.

As shown in FIG. 3, the optical pickup unit 6 includes a lens unit 62, a laser diode board 63, a relay board 64 and the like, which are disposed on a base chassis 61. The relay board 64 is connected to the lens unit 62 via an FFC (flexible flat cable) and is electrically connected to the laser diode board 63. The relay board 64 is also provided with a connector 64a so as to be connectable to an optical-pickup-unit adjustment jig, a traverse-unit adjustment jig, or a control board of the optical disc drive 1, by means of an FFC.

The laser diode board 63 is capable of emitting at least laser beams having two wavelengths for DVDs and CDs. The laser diode board is adapted to emit laser beams at plural wavelengths according to the types of optical discs placed on the tray 2.

As shown in FIG. 4 showing, in enlarged dimension, the potion enclosed by the dot-dash line in FIG. 3, the relay board 64 (equivalent to a “circuit board” of the invention) is provided with short land portions SL1, SL2 for preventing the electrostatic breakdown of laser diodes (not shown) of the laser diode board 63. Specifically, each of the short land portions SL1, SL2 is so constituted as to electrically short a source terminal and a ground terminal of the laser diode and to unshort the terminals. The electrostatic breakdown of the laser diodes may be prevented by electrically shorting the short land portions SL1, SL2.

The short land portions SL1, SL2 of the laser diode each include: a first semicircular land SLP connected with the source terminal of the laser diode; and a second rectangular land SLG as a solder pool, which is connected with the ground terminal of the laser diode. The second land SLG has a size so defined as to pool a sufficient quantity of solder H for allowing the steps of shorting and unshorting the first and second lands SLP, SLG to be repeated plural times.

Next, one example of the short land portion SL1, SL2 will be described with reference to FIGS. 5A through 5C.

FIG. 5A is a plan view of the short land portion, and FIG. 5B and FIG. 5C are sectional views taken on the line A-A in FIG. 5A. FIG. 5B shows a state where the first and second lands SLP, SLG are electrically shorted by way of the solder H, whereas FIG. 5C shows a state where the shorted state of FIG. 5B is eliminated.

As shown in FIG. 4 and FIG. 5, the short land portions SL1, SL2 are each formed in any shape by overlaying an insulative ink film, called a resist SR, on a circuit pattern PW formed on the relay board 64 using a copper foil or the like. As shown in FIG. 5B, the solder H is not deposited on the resist SR.

According to the embodiment, the first land SLP is formed in the semicircular shape whereas the second land SLG is formed in the rectangular shape, as shown in FIG. 5. Additionally, the first land SLP and the second land SLG have respective edges SLP1, SLG1 in opposing relation, which define parallel straight lines of substantially the same length. That is, the second land SLG is configured such that a length ‘a’ of its side SLG1 adjoining the first land SLP is substantially equal to a diameter ‘d’ of the first land SLP.

Next, one example of a method wherein the short land portion SL1, SL2 of the above constitution is electrically shorted or unshorted by way of the solder H will be described with reference to FIG. 5.

First, the short land portion SL1, SL2 is electrically shorted by supplying the solder H to the short land portion SL1, SL2, as shown in FIG. 5B. The solder H may be supplied to the short land portion SL1, SL2 by a so-called reflow method wherein the short land portion SL1, SL2 with a solder paste applied thereto is passed through a heating furnace. Otherwise, a worker may use a soldering iron to supply the solder H.

Subsequently, the worker uses the soldering iron for melting the solder H by heating the short land portion SL1, SL2 shorted as shown in FIG. 5B, and for transferring the molten solder H to the second land SLG. As a result, the most of the solder H shorting the short land portion SL1, SL2 is pooled on the second land SLG, so that the short land portion SL1, SL2 is unshorted, as shown in FIG. 5C.

At this time, a minor amount of the solder H shorting the short land portion SL1, SL2 adheres to the soldering iron. However, the second land SLG is formed in an adequate size so that the surface tension of the solder H on the second land SLG acts to pool the most of the solder H on the second land SLG.

When the short land portion SL1, SL2 is to be reshorted, the worker may use the soldering iron for melting the solder H by heating the short land portion SL1, SL2 in the state of FIG. 5C, and for transferring the solder H on the second land SLG to the first land SLP. Thus, the solder H bridges between the first and second lands SLP, SLG, thereby bringing the short land portion SL1, SL2 into the shorted state.

By the way, there may be a case where a short land portion SL3 is not successfully shorted by using the solder H on a second land SLG2, if the second land SLG2 is too large in the area and has a rectangular shape, the short side of which is equal to a diameter of a first land SLP2, as shown in FIGS. 6A through 6C. FIG. 6A is a plan view of the short land portion, and FIG. 6B and FIG. 6C are sectional views taken on the line B-B in FIG. 6A. FIG. 6B shows a state where first and second lands SLP2, SLG2 are electrically shorted, while FIG. 6C shows a state where the shorted state of FIG. 6B is eliminated. Like components to those of FIG. 5 are represented by corresponding characters, respectively, the description of which is dispensed with.

As shown in FIGS. 6A through 6C, the second land SLG2 of the short land portion SL3 has such a large area that a large quantity of solder H is pooled on the second land SLG2. Therefore, when the short land portion in the unshorted state shown in FIG. 6C is to be brought into the shorted state shown in FIG. 6B by using the same method as that described above, the solder H on the second land SLG2 has such a great surface tension that the soldering iron may not be able to adequately transfer the solder H from the second land SLG2 to the first land SLP2.

It is therefore desirable to previously determine, by experiment, optimum configurations and dimensions of the first and second lands and an optimum gap between the lands.

The embodiment illustrates one example wherein the second land SLG is formed in a square shape, one side ‘a’ of which has substantially the same length as the diameter ‘d’ of the first land SLP. Such a constitution permits the second land SLG to have a greater area than that of the first land SLP so that the second land SLG is able to pool a sufficient quantity of solder for allowing the steps of shorting and unshorting these lands SLP, SLG to be repeated plural times.

According to a most preferred example, the short land portion SL1, SL2 may be constituted, for example, such that the diameter ‘d’ of the first land SLP is about 2.0 mm, that the side ‘a’ of the second land SLG is about 2.0 mm and that a gap G between the first and second lands SLP, SLG is about 0.45 mm.

Next, one exemplary procedure of assembling the above optical pickup unit 6 in the optical disc drive 1 will be described with reference to FIG. 7. FIG. 7 is a flow chart showing the steps of one exemplary procedure of assembling the optical pickup unit 6 in the optical disc drive 1.

First, the short land portions SL1, SL2 on the relay board 64 are previously shorted in order to prevent the electrostatic breakdown of the laser diodes. Then, the optical pickup unit 6 is fabricated by assembling the components including the relay board 64, the lens unit 62, the laser diode board 63, the base chassis 61 and the like (Step S1). Subsequently, the optical pickup unit 6 so fabricated in Step S1 is mounted to the optical-pickup-unit adjustment jig (not shown) and the optical-pickup-unit adjustment jig is connected to the connector 64a of the relay board 64 by means of the FFC (Step S2).

Subsequently, the short land portions SL1, SL2 of the relay board 64 are unshorted (Step S3) to perform the adjustment of the optical pickup unit 6 (Step S4). After completion of the adjustment of the optical pickup unit 6, the short land portions SL1, SL2 of the relay board 64 are reshorted (Step S5). Then, the FFC interconnecting the optical-pickup-unit adjustment jig and the relay board 64 is removed and the optical pickup unit 6 is dismounted from the optical-pickup-unit adjustment jig.

Subsequently, the traverse unit including the optical pickup unit 6 is fabricated (Step S6). The traverse unit fabricated in Step S6 is mounted to a traverse-unit adjustment jig (not shown) (Step S7). The traverse-unit adjustment jig is connected to the connector 64a of the relay board 64 by means of the FFC (Step S8).

Next, the short land portions SL1, SL2 of the relay board 64 are unshorted again (Step S9) to perform the adjustment of the traverse unit (Step S10). After completion of the adjustment of the traverse unit, the short land portions SL1, SL2 of the relay board 64 are reshorted (Step S11). Subsequently, the FFC interconnecting the traverse-unit adjustment jig and the relay board 64 is removed from the connector 64a (Step S12). The traverse unit is dismounted from the traverse-unit adjustment jig (Step S13).

Next, the optical disc drive 1 including the traverse unit is fabricated (Step S14). The control board (not shown) of the optical disc drive is connected to the connector 64a of the relay board 64 by means of the FFC (Step S15). Finally, the short land portions SL1, SL2 of the relay board 64 are unshorted again to complete the procedure of assembling the optical pickup unit 6 in the optical disc drive 1 (Step S16).

According to the embodiment as described above, the second land SLG is formed in such a size as to pool a sufficient quantity of solder H for allowing the steps of shorting and unshorting the first and second lands SLP, SLG to be repeated plural times. Out of the solder H initially supplied for shorting the short land portion SL1, SL2, therefore, a solder portion H bridging the gap between the first and second lands SLP, SLG for shorting may be transferred to and pooled on the second land SLG, whereby the shorted state may be eliminated. Subsequently when the short land portion SL1, SL2 is reshorted, the solder H pooled on the second land SLG may be transferred to the first land SLP so as to short the short land portion SL1, SL2. Unlike the conventional method, the embodiment negates the need for replenishing fresh solder at each shorting step. That is, the solder H initially supplied to the short land portion SL1, SL2 may be used for repeating the shorting and unshorting steps plural times. Thus, the short land portion of the embodiment can save a much greater amount of solder H than the short land portion of the conventional configuration.

The second land SLG has a greater area than the first land SLP so that the most of the solder H may be pooled on the second land SLG in the unshorting step. Thus, the optical pickup unit may be implemented in a useful constitution.

In addition, the opposing sides (opposing edges) SLP1, SLG1 of these lands SLP, SLG have substantially the same length so that the step of shorting or unshorting the short land SL1, SL2 by way of the solder H may be accomplished easily and assuredly.

Furthermore, the first and second lands SLP, SLG of the short land portion SL1, SL2 are formed in the semicircular shape and in the rectangular shape, respectively. This facilitates the formation of a wiring pattern on the relay board 64. What is more, the second land SLG may be so formed as to have the greater area than the first land SLP while the mutually opposing sides SLP1, SLG1 of these lands SLP, SLG have the same length. Thus is provided the optical pickup unit featuring quite a useful constitution.

The use of the optical pickup unit 6 including the aforementioned short land portions SL1, SL2 provides for the fabrication of the optical disc drive 1, wherein the optical pickup unit 6 is assembled in the optical disc drive 1 without wastefully using the solder H.

It is noted that the invention is not limited to the above embodiments and other various modifications than the above may be made thereto without departing from the scope of the invention. For instance, the configurations and sizes of the first and second lands SLP, SLG and the size of the gap G may be varied in various ways.

According to the foregoing embodiments, the short land portions are formed on the relay board 64 in correspondence to the respective laser diodes of the laser diode board 63. However, an alternative constitution may also be made such that a single second land SLG is shared as a common land for ground terminals of the individual laser diodes and that plural first lands SLP are disposed around the second land SLG in correspondence to the respective source terminals of the laser diodes.

The invention is applicable to a variety of optical pickup units 6 for use in the optical disc drive incorporated in the electronic apparatuses as well as to a variety of optical disc drives including the optical pickup unit 6.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An optical pickup device, comprising:
a short land portion provided on a circuit board for the purpose of preventing the electrostatic breakdown of a laser diode,
wherein said short land portion includes at least one first land and at least one second land for solder pooling, said first and second lands subjected to shorting and unshorting steps by way of a solder, and
wherein said second land has a size to pool a sufficient quantity of solder for allowing the steps of shorting and unshorting said lands to be repeated plural times.

2. The optical pickup device according to claim 1, wherein said second land has a greater area than said first land.

3. The optical pickup device according to claim 1, wherein mutually opposing edges of said first land and said second land define parallel straight lines substantially having the same length.

4. The optical pickup device according to claim 2, wherein mutually opposing edges of said first land and said second land define parallel straight lines substantially having the same length.

5. The optical pickup device according to claim 3, wherein said first land has a semicircular shape and said second land has a rectangular shape in which at least a side adjoining said first land has a length substantially equal to a diameter of said first land.

6. The optical pickup device according to claim 4, wherein said first land has a semicircular shape and said second land has a rectangular shape in which at least a side adjoining said first land has a length substantially equal to a diameter of said first land.

7. An optical disc drive comprising the optical pickup device according to any one of claims 1 to 6.
